(19) United States
(12) Patent Application Publication
(10) Pub. No.: US 2019/0172320 A1
(43) Pub. Date: Jun. 6, 2019

(54) Method to Modify Computer-Based Card Games via Non-Uniform Probability Distribution of Cards in a Card Deck

(71) Applicants: Denis Shcharinsky, NORTH YORK (CA); Michael Pozin, Aurora (CA); Faina Pozin, NORTH YORK (CA)

(72) Inventors: Denis Shcharinsky, NORTH YORK (CA); Michael Pozin, Aurora (CA); Faina Pozin, NORTH YORK (CA)

(21) Appl. No.: 15/831,277

(22) Filed: Dec. 4, 2017

(51) Int. Cl. G07F 17/32

(52) U.S. Cl. CPC G07F 17/3293; G07F 17/3272; G07F 17/3262; G07F 17/323

(57) ABSTRACT

A method for modifying a computer-based card game via changing probability of picking one or more cards from a deck or decks of cards. The method includes the following steps:
Initially all cards have equal probability to be drawn from a shuffled deck
The probability to be drawn from the deck for one or more cards in the deck or decks is changed either by program or by the players
The cards are drawn from the deck during the game based on the assigned probability

### CROSS-REFERENCE TO RELATED APPLICATIONS

Not Applicable

### BACKGROUND OF THE INVENTION

### 1. Field of the Invention

This invention relates generally to the field of card games. In particular, it relates to card games implemented using computer programs.

### 2. Description of the Related Art

Playing cards have been around and in use for many centuries by people on every continent. With the invention of computers, most card games were implemented using computer programs as well. The games implemented using computer programs followed their counterparts in the physical world as closely as possible, making switching between real world card games and their computer counterpart easier.

Card games with well-defined and well-known rules in many cases led to development of deep theoretical foundation of game strategies as well as numerous computer-based tools to help players.

Deep game theory and multiple helping computer programs made games less fun for many amateur players. Also in the case of games with monetary prizes, it caused a widespread of cheating where honest players often were competing either against bots or against players using computer-aid.

Another problem with the existing card games is the difficulty of introducing new games. Most card games include a significant number of rules. New players would put an effort to learning the rules only if there is an already large number of existing players. It becomes a catch 22 for new games—new players do not want to learn a new game without critical mass of the existing players and this critical mass cannot be achieved without new players willing to learn and play the game.

### BRIEF SUMMARY OF THE INVENTION

The object of this invention is to allow non-uniform probability distribution for the cards in a deck (or decks) for any computer-based card games. This makes it harder to apply existing well-studied strategies for the game or rely on computer assistance during the game, levelling the game field for the players of all levels and making the game more entertaining for the most players.

Numerous ways to introduce non-uniform probability are listed.

The method proposed may be applied to the very broad category of card games played on a computer. The rules for all of these games do not change at all except for the initial part when non-uniform probability is introduced. This introductory part may be considered as a pre-game phase.

As the concept of non-uniform probability becomes more widely accepted and understood by players probability distribution change may be extended to other parts of the game while still being a minor game modification and keeping main game dynamics intact.

As the suggested method is weakly tied to any specific type of card game it may be universally implemented and easily added to most card games played on a computer.

### BRIEF DESCRIPTION OF THE SEVERAL VIEWS OF THE DRAWING

FIG. 1 is a graph showing probability to pick a card from a shuffled deck of cards (all probabilities are the same (1/52) or, in terms of individual weights, all cards have the same weight of one). This is the case for all existing card games;

FIG. 2 is a graph showing probability to pick a card from a shuffled deck of cards where one card is twice as likely to be drawn (this card has a probability to be drawn of 2/53 while all other cards have the same probability of 1/53 or, in terms of individual weights, all cards have the same weight of one, while one card has the weight equal 2);

FIG. 3 shows probabilities when more than one card has its probability changed;

FIG. 4 is a flowchart where single card weight is changed via an algorithm and this information is shared with all players;

FIG. 5 is a flowchart where weight of two cards is changed via an algorithm and this information is shared with all players;

FIG. 6 is a flowchart where weight of as many cards as there are players is changed via an algorithm and each player is aware of weight changes of one card only;

FIG. 7 is a flowchart where each player has a chance to change the weight of a single card of his choice to some predefined value;

FIG. 8 is a flowchart where each player has a chance to change the weight of one or more cards of his choice based on an outcome as chosen by a rolled die;

FIG. 9 is a flowchart illustrating more complex logic of card weight manipulation. The outcome as given by the die defines either weight changes for the cards or in case of Suit outcome leaves it to a player to choose which suit will have an increased weight.

### DETAILED DESCRIPTION OF THE INVENTION

Most card games usually use one or more decks of cards. A typical assumption in these games that the initial deck is shuffled and cards dealt from the deck are random. The probability to pick a card from the deck is the same for all cards in the deck. Even though chance plays an important role in the game outcome, having a well-defined initial state makes it possible to develop a strategy to play such games, including a computer-based strategy where machines play the game much more effectively. Our method allows to change the probability of one or more cards in the deck (either by players or via a program), making automatic strategy less efficient and the game more exciting. The method may be applied to any type of card game implemented completely or partially as a computer program.

Most card games implemented in software have their origin in the physical version of the same game. They follow all the game rules to the letter making transition to the computer version of the game easier. Players immediately recognize all elements of the game and may start playing immediately without resorting first to the instructions. However, a computer version of any game does not need to be an exact version of the game in the physical world. Physical versions always have inherent limitations of dealing with physical objects. It means it is hard to pick a card from a properly shuffled deck of 52 cards with a probability other than 1/52. (In other words, in a properly shuffled deck of cards we may assign a probability weight of one to every card, the total of all weights becomes 52 and the chance to draw any card from a deck is 1/52).

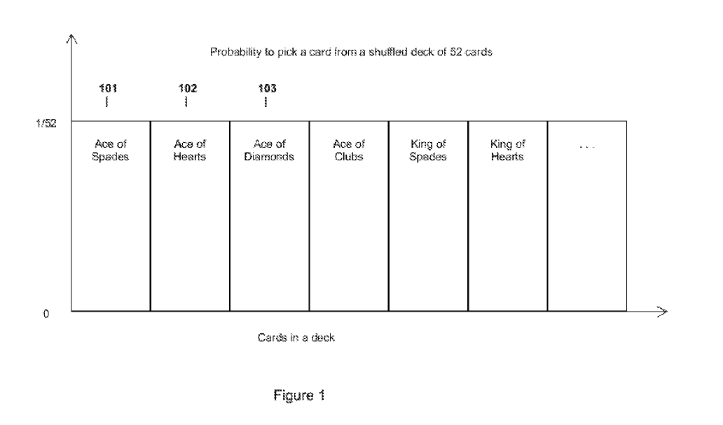

FIG. 1 is a graph showing probability to pick a card from a shuffled deck of 52 cards (all probabilities are the same 1/52 or in term of individual weights all cards have the same weight of one). The probabilities are the same for all existing card games. The chance for an individual card to be drawn is defined only by the number of cards in the deck. Each bar in FIG. 1 represents a probability for an individual card. As the probabilities are equal, the heights of all bars are equal as well (see 101, 102, and 103 in FIG. 1). Alternatively the height of each bar may be interpreted as a weight of each card during a draw, the cards with higher weight/height have a higher chance to be drawn. In FIG. 1 all heights are equal and all weights share the same value (for example weight equals one for all cards).

However changing card probabilities is totally feasible in a computer-based game. Any weight (not just one) may be assigned to any card in a deck. For example, assigning a weight of 2 to the Ace of Hearts in the deck changes the probability to fetch the Ace of Hearts to 2/53 and the probability to fetch any other card to 1/53.

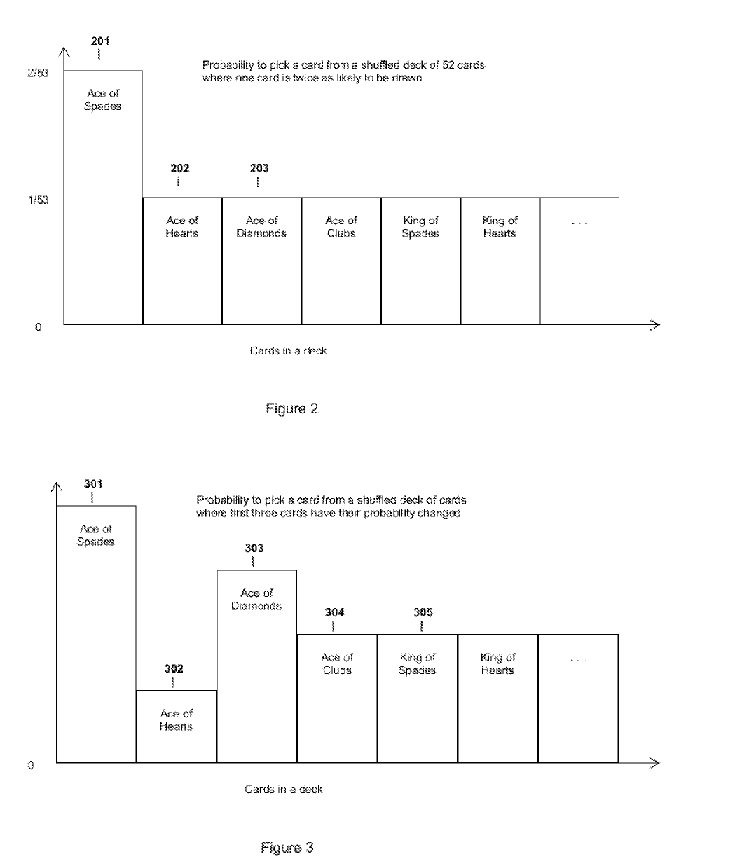

FIG. 2 is a graph showing probability to pick a card from a shuffled deck of cards where one card (201) is twice as likely to be drawn. This card has probability to be drawn of 2/53 while all other cards (202, 203, etc.) have the same probability of 1/53. In terms of individual weights all cards have the same weight of one (202, 203, etc.), while one card has the weight equal 2 (201).

Implementing this scenario in a physical deck would require adding an extra Ace of Hearts, which completely changes most of the games. Imagine having a combination of 5 Aces in Poker—this is a totally different game. To avoid the 5 Aces problem, it is possible every time when a double card is drawn from the deck to manually find and discard its second copy from the deck. This procedure is very awkward and no player would enjoy it.

However assigning a non-uniform probability (non-equal weights) in a computer game is possible without adding any extra cards to the deck. This is where possibilities available in a computer version clearly deviate from its physical world counterpart.

FIG. 3 shows card probabilities when more than one card has its probability changed. Cards 301 and 303 have their probabilities increased, while card 302 has its probability decreased.

Changing card probabilities in a deck randomly does not make any sense if players do not have any information about the change and/or do not have any say in the process. Non-uniform probability would look to them as a flaw in the algorithm at best and as cheating at worse. However if players know (partially or completely) how the probability distribution changed they may plan their game strategy accordingly.

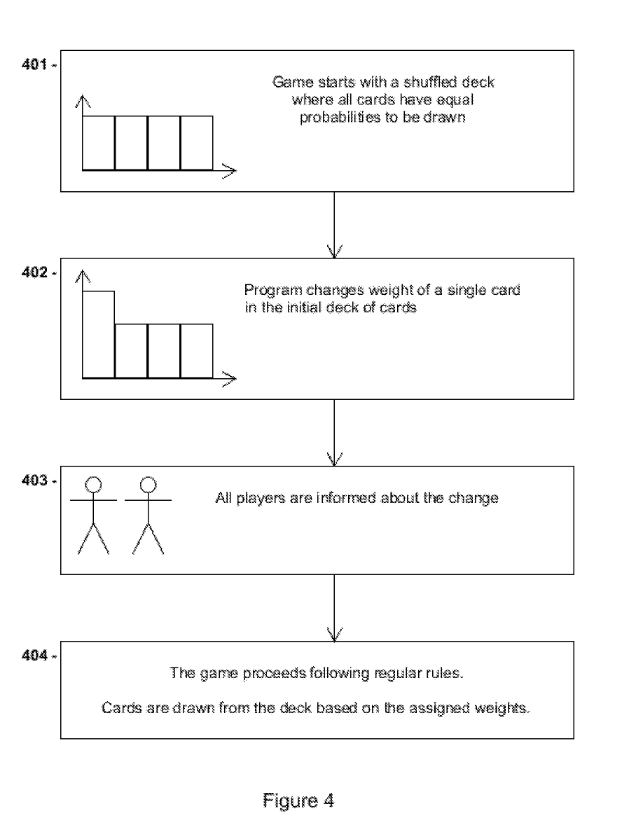

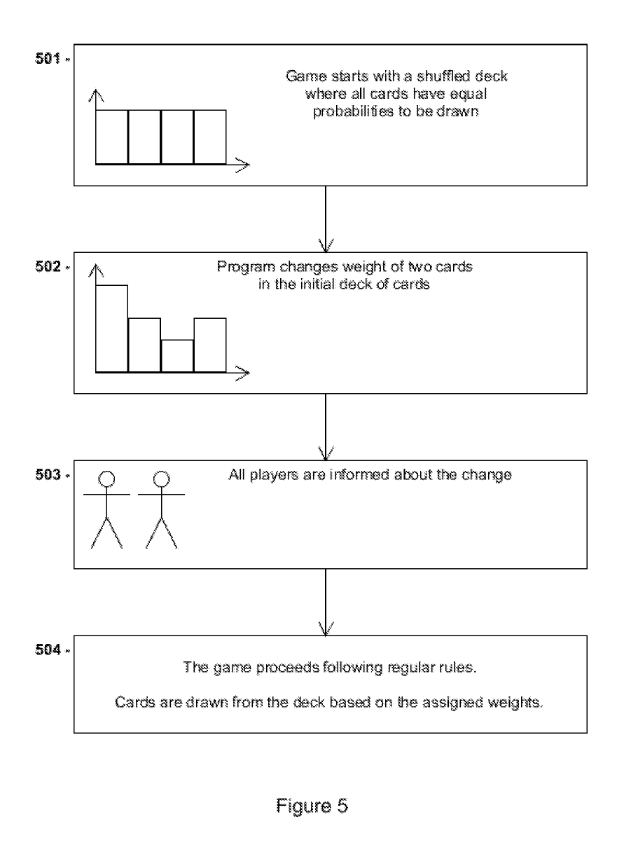

The complete knowledge of distribution change refers to the case when all players have exactly the same information about the change. This scenario is shown in FIG. 4 and FIG. 5 and further discussed below.

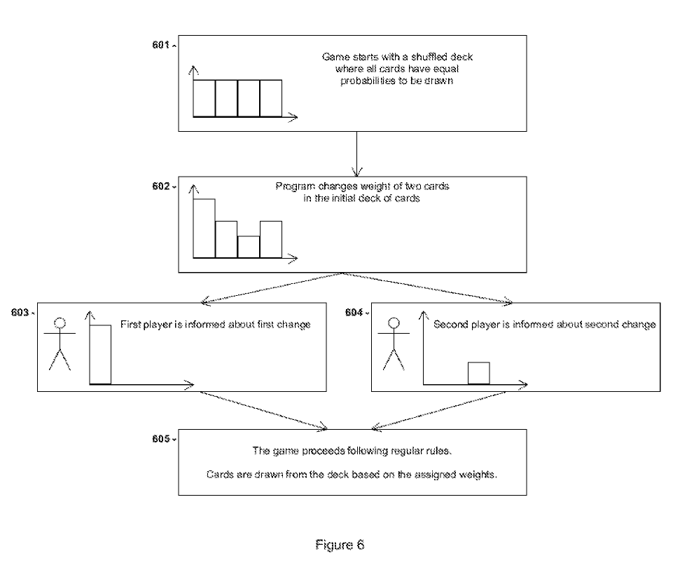

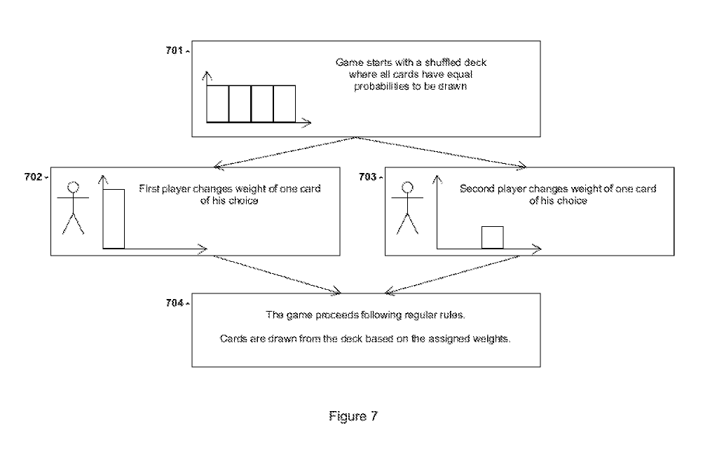

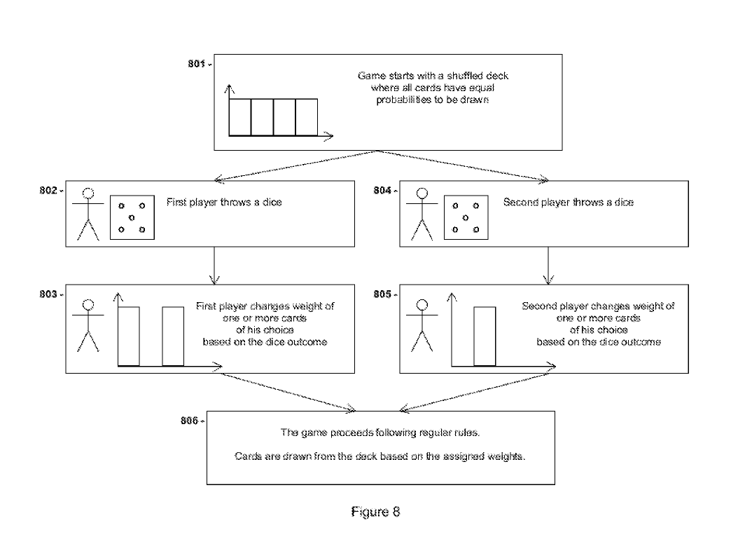

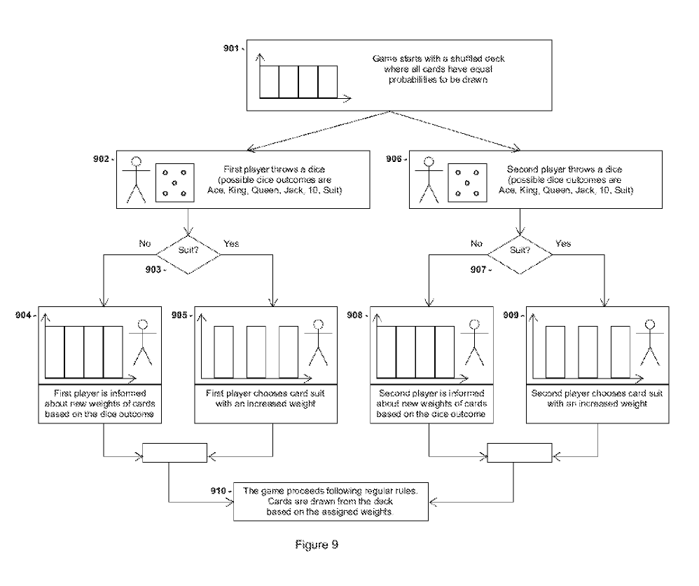

The partial knowledge refers to the case where each player knows about some changes in the distribution (i.e. has incomplete information about the distribution). This scenario is presented in FIG. 6. The variation of the latter case is when each player has some control over how this distribution changes as shown in FIG. 7. The latter scenario may be further advanced with introduction of a random device (for example a die), which further increases uncertainty in the options available to the players. These scenarios are illustrated in FIG. 8 and FIG. 9. FIG. 6-FIG. 9 are discussed in more details below.

As all changes in the deck happen before the game commences (in its original form anyway), all the games follow exactly the same rules as before. The game will go exactly through the same phases and the possible winning outcomes are still exactly the same (there will be no 5 aces in poker). At the same time, the game strategy for all players will change as they now have additional knowledge about the deck. This change will make simple memorization of winning strategies less effective and will value more player intuition. It will also make most of the current bots less efficient as well leveling the playing field for human players. As the actual rules for the initial deck change may vary wildly making a universal bot for the ever-changing rules becomes harder.

While in theory changing deck probability distribution may affect all cards in the deck, such a change would be highly impractical as a human player would not be able to memorize all the changes. This means that, in practice, the changes in each round must be made only to a few elements in the deck (it may be individual cards, cards of the same value or cards with the same suit). The change in distribution for the individual elements may go either in both directions (increased probability/weight for some elements and decreased probability/weight for the other elements), or it may be limited to only one direction (either increase or decrease). In addition, the weight increases are suggested to be in increments of one, while weight decreases should prefer some simple fraction like ½, ¼ and so on. Having a card's weight set to zero effectively removes the card from the deck.

The methodology of changing the probability distribution of the cards in the deck is less important, as there are numerous ways to go about the implementation. A few possible ways to introduce these changes are described in detail below.

In what follows a few possible scenarios are illustrated.

FIG. 4. Changing single card weight via algorithm and sharing this information with all players.

401. Game starts with a shuffled deck where all cards have equal probabilities to be drawn.
402. The program changes weight of a single card in the initial deck of cards (e.g. the weight of Ace of Hearts is increased to 2).
403. All players are informed about the change (i.e. they know that single card Ace of Hearts is twice as likely to be drawn).
404. The round of the game follows.

The steps 401-404 are then repeated as follows:

401. No change.
402. Before starting a new round another card weight is changed (e.g. the weight of King of Spades is increased to 2).
403. All players are informed about the change as before (i.e. they know that the single card King of Spades is twice as likely to be drawn).
404. The next round of the game follows.
[the steps 401-404 are repeated again and again]

FIG. 5. Changing weight of two cards via an algorithm and sharing this information with all players.

501. Game starts with a shuffled deck where all cards have equal probabilities to be drawn.
502. The program changes weights of two cards in initial deck of cards (e.g. the weight of Ace of Hearts is increased to 2 and the weight of King of Spades is decreased to 0.5).
503. All players are informed about the change (i.e. they know that Ace of Hearts weight is 2 and King of Spades weight is 0.5, meaning that Ace of Hearts is 4 times more likely to be drawn).
504. The round of the game follows.

The steps 501-504 are repeated with other cards chosen for the weight change and other weight values are assigned. All weight changes are limited to 2 and 0.5 in this scenario.

FIG. 6. Changing weight of as many cards as there are players via algorithm and sharing information about single card with each player.

Let's assume for simplicity that there are two players in the game.

601. Game starts with a shuffled deck where all cards have equal probabilities to be drawn.
602. The program changes weights of two cards in initial deck of cards (e.g. the weight of Ace of Hearts is increased to 2 and the weight of King of Spades is decreased to 0.5).
603. The first player is informed about the Ace of Hearts change and the second player is informed about King of Spades change.
604. The round of the game follows.
The steps 601-604 are repeated with other cards chosen for the weight change and other weight values are assigned.

FIG. 7. Each player has a chance to change weight of a single card of his choice to some predefined value.

Let's assume for simplicity that there are two players in the game.

701. Game starts with a shuffled deck where all cards have equal probabilities to be drawn.
702. The first player changes the weight of Ace of Hearts to 2 and does not share this information with other player.
703. The second player changes the weight of King of Spades to 2 and does not share this information with other player.
704. The round of the game follows.

The steps 701-704 are repeated. The players may choose either the same cards each round or different cards.

FIG. 8. Each player has a chance to change weight of one or more cards of his choice based on dice outcome.

Let's assume for simplicity that there are two players in the game.

801. The game starts with a shuffled deck where all cards have equal probabilities to be drawn.
802. The first player throws an electronic die, which results in a score from 1 to 6.
803. The first player increases the weight of one or more cards so that total sum of weight increases equals to the dice score shown by the die. For example if the score shown by the die is 3 the player may increase the Ace of Hearts weight to 3 (increase of +2) and also increase the weight of the King of Spades to 2 (increase of +1). The player does not share this information with other players.
804. Step 802 is repeated for the second player (throwing the die).
805. Step 803 is repeated for the second player (changing weights for the cards of the player's choice).
806. A round of play follows.

Steps 801-806 are repeated.

FIG. 9. A flowchart illustrating more complex logic of card weight manipulation. The dice outcome either defines weight changes for the cards or, in the case of a Suit outcome, leaves it to a player to choose which suit will have an increased weight.

901. The game starts with a shuffled deck where all cards have equal probabilities to be drawn.
902. The first player throws an electronic die and the possible outcomes are: Ace, King, Queen, Jack, 10, Suit.
903. Two different branches are possible based on the die outcome.
904. If the outcome shown by the die is not a Suit, then the weight is changed to 2 for all cards based on the die outcome. For example, an Ace outcome means all Aces in the deck will have a weight of 2.
905. If the die outcome is a Suit, then the first player decides to which one of the four available suits the weight increase must be applied. All cards with the selected Suit will have an increased weight of 2.
906-909. Steps 902-905 are repeated for the second player.
910. The round of the game follows.

Steps 901-910 are repeated.

In all scenarios above card weight increases provided either by a program or selected by a player are always combined when the card is randomly drawn from a deck during the game. In particular, if both players apply the same weight increase to the same card, the chance to draw this card from the deck proportionally increases as well (relative to the case when only one player increases the weight for the card).

Limiting card game changes to the initial deck probability distribution achieves the following:
It invalidates many well-studied game playing strategies (either memorized in players' heads or implemented via software), levelling game field and preventing cheating via computer-aided means.
It does not require any changes in the rules of the original game, making adoption of the changes easier. All changes are effectively localized to the initial pre-game stage.

Limiting deck changes to the initial phase of the game is suggested only as means to accelerate adoption of this approach. As this approach gains popularity, a similar approach can be implemented during other parts/times during a game. If the original rules of the game are preserved, constant game variability is not considered by players as invasive, but instead increases the perceived randomness of the game. It might not be appreciated by professional players as game variations will invalidate many of the game theories they studied before, but this is exactly what would make game more interesting to the majority of the players.

Card probability distribution can be allowed to change dynamically at different parts of the game. This type of variability opens numerous other avenues of possible subtle changes in the game dynamics:
Number of players having access to probability adjustments may change randomly from round to round. For example, in one round of the game player 1 has a chance to change a card's weight, while in another round it may be player 2 making the decision.
Information disclosed to other players about who has the right to change the card's weight may be incomplete and asymmetrical. For example, player 1 may know about player 2, but the same information is withheld from player 3 in the current round. Exact information about changes made by other players may be sometimes available to some of the players. Information about changes made by other players may become gradually available as the game proceeds. For example, a player 2 may be informed about changes made by player 1 only after the first round of betting (or some other event in the game).
Players may have an option to cancel partially (or completely) any changes made by other players based on some other random factors. Information about cancellation may or may not be propagated to some or all other players.

While game variability looks overwhelming in fact players' choices are very simple at each particular moment. They are always about changing some probability distribution of the cards in the deck or about information regarding these changes. The decisions to be made at each such junction are relatively simple so they do not distract players too much from the core part of the game. At the same time, these constant unpredictable changes make brute-force calculations less effective and computing tools not able to adjust to the constantly changing game rules.

While many simple scenarios presented in FIG. 4-9 suggest that the approach does not change between game rounds, in the race to invalidate computer programs aiding unscrupulous players this will not necessarily be the case. The selected approach may vary from round to round.

Various changes in the details, steps and components that have been described may be made by those skilled in the art within the principles and scope of the invention herein illustrated and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

1. A method for modifying a computer-based card game via changing probability of picking one or more cards from a deck of cards comprising the steps:
starting with the assumption that all cards have equal probability to be drawn
changing card probability to be drawn from said deck for one or more cards in the deck
providing cards from the deck during the game based on the assigned probability

2. The method from claim 1 where said probabilities are assigned automatically by a program and all players are informed about values of said probabilities

3. The method from claim 1 where each player assigns a probability to one or more cards and does not share the knowledge of this probability with the rest of the players

4. The method from claim 1 where each player assigns a probability to one or more cards where assigned number of said cards and their probabilities are further constraint by random device outcome and the player does not share knowledge of the assigned probabilities with the rest of the players

5. The method from claim 1 where a player is allowed to change a probability of one or more cards to be drawn during the game

6. The method from claim 1 where a probability to be drawn from a deck is provided by a program for some cards and a player is allowed to change a probability of one or more other cards

7. The method from claim 1 where multiple decks are allowed

8. The method from claim 1 where players who are allowed to change probability of one or more cards are randomly selected by a program
